(19) United States
(12) Patent Application Publication
(10) Pub. No.: US 2025/0151691 A1
(43) Pub. Date: May 15, 2025

(54) ENVIRONMENTALLY FRIENDLY DISPOSABLE ARTICLE FOR COVERING AN ANIMAL ENCLOSURE

(71) Applicant: Natalie Parker, Stroudsburg, PA (US)

(72) Inventor: Natalie Parker, Stroudsburg, PA (US)

(21) Appl. No.: 18/333,523

(22) Filed: Jun. 12, 2023

(51) Int. Cl. A01K 1/015

(52) U.S. Cl. CPC A01K 1/0157

(57) ABSTRACT

A disposable article for covering an animal enclosure, the article comprising a plurality of layers. Each layer is disposed one on top of another. Each layer comprises a plurality of individual square sections. Each section is connected together along a perforated edge, and each section is configured to be removed separately from the layer without removing the entire layer. The article comprises a disposable material adapted for absorbing animal waste.

### FIELD OF THE INVENTION

This disclosure generally relates to animal care. Specifically, this disclosure relates to an environmentally friendly disposable liner for covering an animal enclosure adapted for absorbing animal waste.

### BACKGROUND

Most reptile owners use fabric rugs or carpets in their enclosures. Some owners use paper liners. In both cases, rugs and paper liners are often used to cover the entire reptile enclosure wall to wall, thus making clean up a major undertaking. The owner has to use paper towels and chemicals to scrub feces off the rug or paper liner every time reptile goes, and also must replace the rug or paper liner every few weeks as they become dirty and contaminated with fecal residue.

The invention described herein the present disclosure is aimed towards solving the problem of difficult and cumbersome maintenance and clean-up of reptile habitats. The present disclosure includes a disposable article or articles for covering an animal enclosure, the articles adapted for absorbing animal waste, and wherein the articles are easily removable from the enclosure.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

Embodiments of the present invention comprise disposable articles for covering an animal enclosure, the articles adapted for absorbing animal waste, wherein the articles are easily removable from the enclosure.

The present invention includes a disposable article for covering an animal enclosure, the article comprising a plurality of layers. Each layer is disposed one on top of another. Each layer comprises a plurality of individual square sections. Each section is connected together along a perforated edge, and each section is configured to be removed separately from the layer without removing the entire layer. The article comprises a disposable material adapted for absorbing animal waste. In the preferred embodiment, the article comprises a recyclable organic material that is non-toxic, safe for animals, and not harmful to the natural environment.

### BRIEF DESCRIPTION OF THE DRAWINGS

The following drawings are intended to serve as exemplary embodiments of the features disclosed in the present disclosure.

FIG. 1 is a diagram illustrating an exemplary article for covering an animal enclosure;

FIG. 2 is a diagram illustrating a plurality of articles arranged as a multi-layer embodiment;

FIG. 3 is a diagram illustrating an exemplary article covering an animal enclosure; and

FIG. 4 is a flowchart illustrating an exemplary method of using said article.

### DETAILED DESCRIPTION OF DRAWINGS

The description of illustrative embodiments according to principles of several illustrative embodiments is intended to be read in connection with the accompanying drawings, which are to be considered part of the entire written description. In the description of embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits are illustrated by reference to certain exemplified embodiments and may not apply to all embodiments.

Accordingly, the invention expressly should not be limited to such exemplary embodiments illustrating some possible non-limiting combination of features that may exist alone or in other combinations of features; the scope of the claimed invention being defined by the claims appended hereto.

This disclosure describes the best mode or modes of practicing the invention as presently contemplated. This description is not intended to be understood in a limiting sense but provides an example of the invention presented solely for illustrative purposes by reference to the accompanying drawings to advise one of ordinary skill in the art of the advantages and construction of the invention. In the various views of the drawings, like reference characters designate like or similar parts.

The present disclosure includes a novel disposable article for covering an animal enclosure, adapted for absorbing animal waste, that is easily removable from the enclosure. A pet owner lays down the absorbent squares next to each other like tiles, as well as stacks the squares in multiples layers. When an animal goes on the square, the owner removes one of the squares soiled with feces and then may throw it in the trash or flush it down a toilet. The animal owner is no longer required to clean the entire animal enclosure after each time animal goes, thus eliminating extra clean-up work, lingering bacteria in the enclosure, and foul smell in trash can, as it is well known to owners that reptiles' feces are notoriously smelly. Accordingly, the present invention effectively reduces the average time to clean an enclosure after an animal has defecated inside of it by approximately 95%. Further, the present invention eliminates the need to replace an enclosure rug every few weeks, eliminating the need to remove reptiles and their accessories out of their enclosure to be able to replace the entire enclosure liner. Further, the present invention eliminates the need to use chemicals to clean feces inside of the animal enclosure. The present invention effectively saves animal owners time and money, as well as the environment.

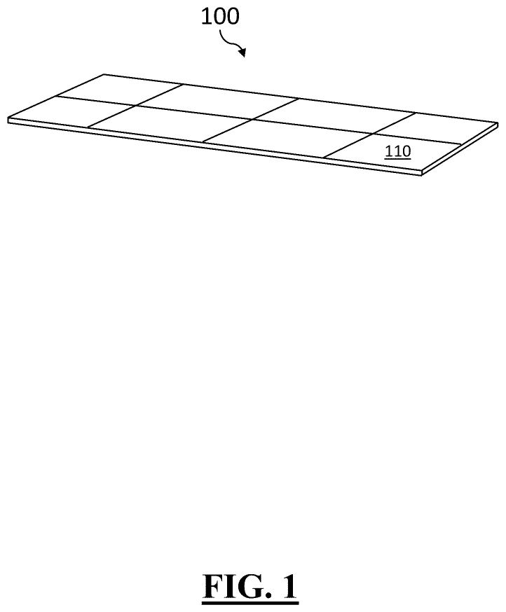

FIG. 1 is a diagram illustrating an exemplary embodiment of an article for covering an animal enclosure. The article 100 may comprise at least one sheet, the sheet comprising a top surface, a bottom surface, and a plurality of edges. The at least one sheet may further comprise a plurality of sections or tiles 110 connected to one another along a perforated edge. Each side of the four sides of each tile 110 is connected to another side of a tile 110, forming a plurality of tiles 110 connected by their sides. The at least one sheet 100 is adapted for absorbing animal waste. In some embodiments, the article 100 or articles 100 are arranged as a plurality of sheets, wherein one layer 100 sits on top of another layer 100.

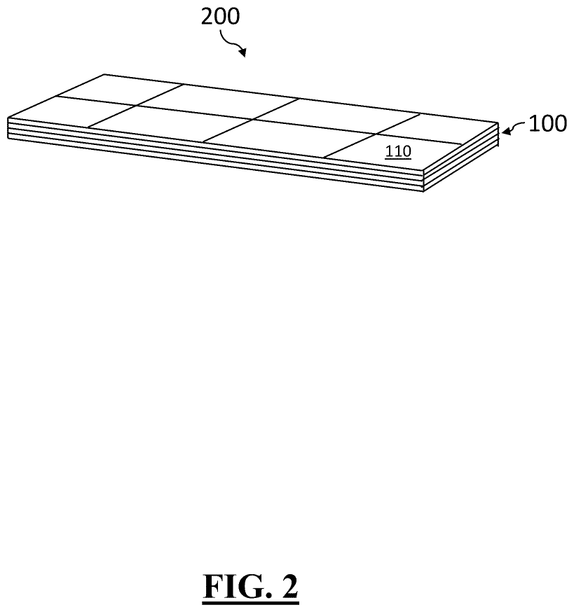

FIG. 2 is a diagram illustrating a plurality of articles 100 forming a multi-layer article 200. With reference to FIG. 2, each of the articles 100 forming the multi-layer article 200 are stacked upon each other collectively forming the multi-layer article 200. When an animal soils the multi-layer article 200, the user does not need to replace the entire article 200. Instead, the user only removes a section 110 of the layer 100 of the multi-layer article 200 that has been soiled.

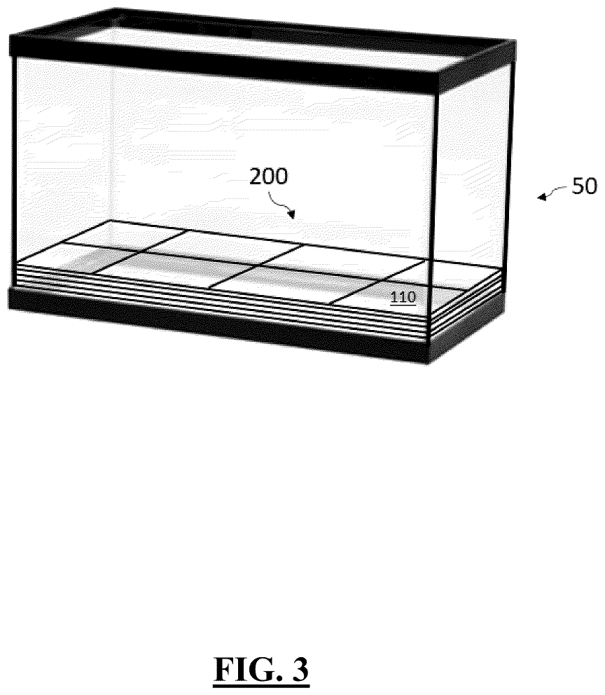

FIG. 3 is a diagram illustrating a multi-layer article 200 disposed within an animal enclosure 50. With reference to FIG. 3, the article 200 may cover the entire bottom surface of the enclosure 50. In some embodiments, the article 200 may be custom fit to accommodate for any decorations, features, or other objects within the enclosure 50. The article 200 may be manufactured in any size suitable to fit within a standard animal enclosure.

In the preferred embodiment, the articles 100 comprise an absorbent material adapted for absorbing animal urine, feces, blood, and any other fluids or emissions produced by animals. In some embodiments, the articles comprise at least one of the following: Polyvinyl Alcohol, Polyitaconic Acid, Polyacrylamide, and/or Polysaccharides.

In the preferred embodiment, the articles 100 comprise recycled organic materials that are non-toxic, safe for animals, and may be safely disposed of and easily decompose along with ordinary sewage, and/or may be safely disposed in the natural environment without causing harm to the natural environment. In some embodiments, the soiled sections of the articles 100 may be flushed down a toilet once they have been soiled In some embodiments, the articles 100 may comprise organic materials that are readily recyclable into soil amendments, including compost, mulch, and liquid fertilizers, as well as biofuel. In some embodiments, the articles 100 comprise a recycled organic cotton material. In some other embodiments, the articles 100 comprise a recycled organic cotton-blend material, wherein the organic cotton-blend material comprises recycled organic cotton as well as other organic recycled materials, such as bamboo. In some embodiments, the articles comprise entirely of natural plant fibers. In some embodiments, the articles comprise a water-soluble material, wherein the water-soluble material is adapted to dissolve in water with ordinary sewage.

In some embodiments, the articles 100 may comprise of at least one of the following colors: brown, green, grey, black. It is contemplated that the article may comprise of a plurality of colors, in order to effectively mimic a natural environment. It is contemplated that said colors may provide a benefit, the benefit being that the article may camouflage with the surroundings within the enclosure. Accordingly, providing a color that camouflages with a habitat within the enclosure may put the animal at ease, and may prevent the animal from experiencing stress caused by having an article within their enclosure that is not of a color native to the animal's natural environment. Further, it is contemplated that providing a color that camouflages with the surroundings of the animal enclosure may be aesthetically pleasing to the animal owner.

The present invention eliminates the need for the owner to scrub feces off the rug or paper liner. The owner simply picks a small, soiled square with feces and flushes it down the toilet or throws it in a bin. Further, the present invention eliminates the need to replace rugs or paper liners every few weeks since no feces ever touch it, because all fecal matter and all animal waste is contained in the article. Further, the present invention eliminates the need to use harsh chemicals in the enclosure since there is no fecal residue ever left.

In some embodiments, the article comprises an antibacterial material. In some embodiments, the antibacterial material may comprise one or more organic compounds. In some embodiments, the antibacterial material may comprise, but is not limited to, bay, cinnamon, clove, thyme, oregano, garlic, parsley, coriander, rosemary, lemongrass, and any combination thereof. In some embodiments, the antibacterial material may comprise charcoal. It is contemplated that other organic compounds, plants, herbs, oils, and spices may be incorporated based on their antimicrobial properties. It is further contemplated that the use of the materials mentioned may also be effective in masking, eliminating and/or absorbing odors caused by animal waste.

In order to change a traditional rug or paper liner, one has to remove everything from the enclosure, including a reptile, which can be time consuming and even dangerous for the reptile, especially when there are other pets or children in the house. Using the present invention, a user only must remove and replace one square tile at a time, without ever having to disturb the animal in the enclosure. It is contemplated that reducing stress caused by unnecessary disturbances may have a positive effect on the longevity of the animal.

The invention described in the present disclosure may be used in the following exemplary manner: covering a cage with squares, waiting for an animal soil at least one square, removing the square from the cage, disposing the square, and replacing the square with a fresh new square.

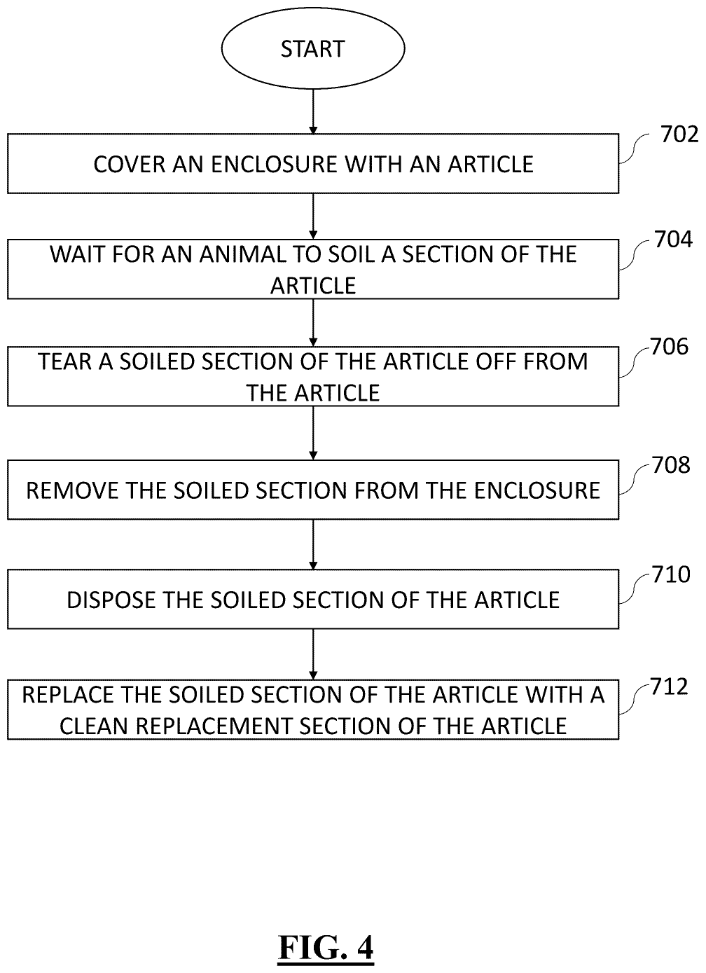

FIG. 4 is a flowchart illustrating an exemplary method of using the article or articles described herein the present disclosure. First, at step 702, an animal owner covers an animal enclosure with an article adapted for absorbing animal waste. The article may comprise a plurality of layers, each layer comprising a plurality of squares connected along perforated edge. Next, at step 704, the owner waits for an animal to soil a section of the article. Next, at step 706, the user tears off a soiled section of the article from the entire article. Due to the design of the article, the owner does not need to wash or dispose of the entire article when an animal soils it. Instead, the owner only needs to dispose of the soiled section, and leave the clean, un-soiled remainder of the article intact in the enclosure. Next, at step 708, the owner removes the soiled section from the enclosure. Next, at step 710, the owner disposes of the soiled section of the article. Finally, at step 712, the owner replaces the soiled section of the article with a clean replacement section of the article. By only removing and replacing sections of the article as needed, the owner need not remove the entire contents of the enclosure to clean it as frequently, thus preserving the environment and tranquility of the animals inside of the enclosure.

While the present invention has been described with reference to enclosures for reptiles, it is contemplated that this present invention may be suitable for other types of animal enclosures as well, including bird enclosures. It further contemplated that the present invention may be adapted for any type of animal enclosure.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A disposable article for covering an animal enclosure, the article comprising:
a plurality of layers;
wherein each layer is disposed one on top of another;
wherein each layer comprises a plurality of individual square sections;
wherein each section is connected along a perforated edge, and each section is configured to be removed separately from the layer without removing the layer from the enclosure; and
wherein the article comprises an absorbent disposable material adapted for absorbing animal waste.

2. The article of claim 1, wherein the article comprises a water-soluble material.

3. The article of claim 1, wherein the article comprises an organic plant fiber material.

4. The article of claim 1, wherein the article comprises a readily recyclable biodegradable material.

5. The article of claim 1, wherein the article comprises an antibacterial material.

6. The article of claim 1, wherein the article comprises a color that camouflages with a habitat within the animal enclosure.

7. A method, the method comprising the steps of:
covering an animal enclosure with a disposable article adapted for absorbing animal waste;
waiting for an animal to soil a section of the article;
removing a soiled section of the article;
disposing the soiled section; and
replacing the soiled section with a new clean section.

8. The method of claim 7, wherein disposing the soiled section further comprises flushing the soiled section down a toilet.

9. The method of claim 7, wherein disposing the soiled section further comprises composting the soiled section.

10. The method of claim 7, wherein disposing the soiled section further comprises recycling the soiled section into mulch.

11. The method of claim 7, wherein disposing the soiled section further comprises recycling the soiled section into a soil amendment.

12. The method of claim 7, wherein disposing the soiled section further comprises recycling the soiled section into liquid fertilizer.

13. The method of claim 7, wherein disposing the soiled section further comprises recycling the soiled section into biofuel.
